(19) United States
(12) Patent Application Publication
(10) Pub. No.: US 2017/0288236 A1
(43) Pub. Date: Oct. 5, 2017

(54) METHOD FOR PRODUCING FUEL CELL CATALYST LAYER

(71) Applicant: TOYOTA JIDOSHA KABUSHIKI KAISHA, Toyota-shi (JP)

(72) Inventors: Tatsuya ARAI, Susono-shi (JP); Takashi OZAKI, Gotenba-shi (JP)

(21) Appl. No.: 15/467,496

(22) Filed: Mar. 23, 2017

(30) Foreign Application Priority Data
Apr. 4, 2016 (JP) 2016075382

(51) Int. Cl. H01M 4/92; H01M 4/86

(52) U.S. Cl. CPC H01M 4/925; H01M 4/8663; H01M 2008/1095

(57) ABSTRACT

A fuel cell catalyst layer includes an SnO₂ support usable in a wide range of humidity environments and provides high power generation from low to high loads. A production method includes the steps of preparing a catalyst composite of an SnO₂ support and platinum or a platinum alloy supported on a surface thereof, and an ionomer that is a proton-conductive polymer; mixing the catalyst composite, the ionomer and a dispersion medium containing at least water and an alcohol having 3 or 4 carbon atoms where the alcohol content is higher than the water, and where a mass ratio (I/MO)) of the ionomer to the SnO₂ support is 0.06 to 0.12, and a solid content of the catalyst composite and the ionomer is 24% by mass or more; and dispersing aggregates of the catalyst composite and the ionomer in the dispersion medium by pulverizing by shear force, while preventing reaggregation of the aggregates by applying force.

### RELATED APPLICATIONS

This application claims priority to Japanese Patent Application No. 2016-075382, filed Apr. 4, 2016, which is hereby incorporated by reference herein in its entirety.

### TECHNICAL FIELD

One or more embodiments disclosed and described herein relate to a method for producing a fuel cell catalyst layer.

### BACKGROUND

In general, a catalyst layer for polymer electrolyte fuel cells, which comprises a catalyst, an electroconductive support supporting the catalyst, and an ionomer that is a proton-conductive polymer, functions as an electrode or a part of an electrode and is combined with an electrolyte membrane to function as a membrane electrode assembly (MEA).

In Patent Literature 1, an electrode and a production method thereof are disclosed, the electrode comprising catalyst particles (carbon black particles on which a catalyst metal is supported) and a polymer ion-exchange component. Patent Literature 1 discloses that the weight of the carbon black particles and that of the polymer ion-exchange component are determined as Wc and Wp, respectively, and an electrode that enables a fuel cell to work in non-humidified conditions, can be produced by setting the ratio of Wc and Wp as follows: 0.4≦Wp/Wc≦1.25.

Meanwhile, an electrode catalyst is disclosed in Patent Literature 2, which comprises, as an electroconductive oxide support that is less likely to be deteriorated by changes in potential compared to carbon supports, a tin oxide comprising one or more added elements selected from the group consisting of Nb, Sb, Ta, In and V, and a noble metal catalyst that is supported on the surface of the oxide support.

### SUMMARY

However, in the case where a conventionally-known method as disclosed in Patent Literature 1 is employed to produce a fuel cell catalyst layer and, in place of a carbon support that is generally used in the conventionally-known method, a tin oxide (SnO₂) support is used for the purpose of obtaining a fuel cell catalyst layer that shows high stability at high potentials, the thus-produced fuel cell catalyst layer has difficulty in adapting to a wide range of humidity environments where a fuel cell is expected to be used, and in providing high power generation performance over a range of from low to high loads.

Patent Literature 1: Japanese Patent Application Laid-Open No. 2002-100367

Patent Literature 2: International Publication No. WO2015/050046

One or more embodiments disclosed and described herein were achieved in light of the above circumstance. An object of the one or more embodiments disclosed and described herein, is to provide a method for producing a fuel cell catalyst layer which may comprise an SnO₂ support and which is configured to be usable in a wide range of humidity environments and provide high power generation performance over a range of from low to high loads.

In a first embodiment, there is provided a method for producing a fuel cell catalyst layer, the method comprising the steps of: preparing a catalyst composite that comprises an SnO₂ support and platinum or a platinum alloy supported on a surface thereof, and an ionomer that is a proton-conductive polymer; mixing the catalyst composite, the ionomer and a dispersion medium containing at least water and an alcohol having 3 or 4 carbon atoms where a content ratio of the alcohol is higher than the water, in such conditions that a ratio (I/MO) of a mass (I) of the ionomer to a mass (MO) of the SnO₂ support is in a range of from 0.06 to 0.12, and a content of a solid comprising the catalyst composite and the ionomer is 24% by mass or more; and dispersing aggregates comprising the catalyst composite and the ionomer in the dispersion medium, by pulverizing the aggregates by applying shear force, while preventing reaggregation of the pulverized aggregates by applying force.

In the mixing step, the ratio (I/MO) of the mass (I) of the ionomer to the mass (MO) of the SnO₂ support may be in a range of from 0.10 to 0.12.

The alcohol may be t-butanol or isopropanol.

A planetary ball mill may be used in the dispersing step, or a ball mill or mixer may be used in combination with a homogenizer in the dispersing step.

The ionomer may be a perfluorocarbon sulfonic acid polymer comprising an acidic functional group and a cyclic group.

According to the one or more embodiments disclosed and described herein, the method for producing the fuel cell catalyst layer which may comprise an SnO₂ support and which is configured to be usable in a wide range of humidity environments and provide high power generation performance over a range of from low to high loads, can be provided.

### BRIEF DESCRIPTION OF THE DRAWINGS

FIG. 1 is a chart showing the power generation performances in different relative humidity conditions and under low loads of fuel cells comprising catalyst layers produced in Examples 1 to 3 and Comparative Examples 1 to 3;

FIG. 2 is a chart showing the power generation performances under low and high loads of the fuel cells comprising the catalyst layers produced in Examples 1 to 3 and Comparatives Examples 1 to 3;

FIG. 3 is a photograph of the surface of a catalyst layer produced in Example 4;

FIG. 4 is a photograph of the surface of a catalyst layer produced in Comparative Example 4; and

FIG. 5 is a schematic view of catalyst composites covered with ionomers.

### DETAILED DESCRIPTION

The method for producing the fuel cell catalyst layer according to one or more embodiments disclosed and described herein, comprises the steps of: preparing a catalyst composite that comprises an SnO₂ support and platinum or a platinum alloy supported on a surface thereof, and an ionomer that is a proton-conductive polymer; mixing the catalyst composite, the ionomer and a dispersion medium containing at least water and an alcohol having 3 or 4 carbon atoms where a content ratio of the alcohol is higher than the water, in such conditions that a ratio (I/MO) of a mass (I) of the ionomer to a mass (MO) of the SnO₂ support is in a range of from 0.06 to 0.12, and a content of a solid comprising the catalyst composite and the ionomer is 24% by mass or more; and dispersing aggregates comprising the catalyst composite and the ionomer in the dispersion medium, by pulverizing the aggregates by applying shear force, while preventing reaggregation of the pulverized aggregates by applying force.

In general, a carbon support that has been used as the electroconductive support of a catalyst for a fuel cell catalyst layer, is likely to deteriorate at high potentials. To solve this problem, an SnO₂ support that is stable at high potentials may be used for a fuel cell catalyst layer.

Relating to a fuel cell catalyst layer comprising a carbon support, a technique for producing a fuel cell catalyst layer is known, which is able to adapt to a wide range of humidity environments where a fuel cell is expected to be used, by setting the mass ratio of the carbon support and an ionomer in a catalyst ink to a preferable range.

However, due to differences in characteristics between the carbon and SnO₂ supports, a catalyst layer that is configured to be usable in a wide range of humidity environments and provide high power generation performance over a range of from low to high loads, cannot be obtained just by replacing the carbon support used in the production method with the SnO₂ support.

According to the one or more embodiments disclosed and described herein, a fuel cell catalyst layer which may comprise an SnO₂ support and which is configured to be usable in a wide range of humidity environments and provide high power generation performance over a range of from low to high loads, can be produced, the method featuring all of the following characteristics: (1) the ratio (I/MG) of the mass (I) of the ionomer that is the proton-conductive polymer (hereinafter it may be simply referred to as “ionomer”) to the mass (MO) of the SnO₂ support is in a range of from 0.06 to 0.12; (2) the content of the solid comprising the ionomer and the catalyst composite that comprises the SnO₂ support and platinum or a platinum alloy supported on the surface, is 24% by mass or more; (3) the dispersion medium contains at least water and an alcohol having 3 or 4 carbon atoms and the content ratio of the alcohol is higher than the water, is used; and (4) the aggregates comprising the ionomer and the catalyst composite that comprises the SnO₂ support and the platinum or platinum alloy supported on the surface thereof, are dispersed in the dispersion medium, by pulverizing the aggregates by applying shear force, while preventing the reaggregation of the pulverized aggregates by applying force.

Hereinafter, the fuel cell catalyst layer production method of the one or more embodiments disclosed and described herein, will be described step by step.

### 1. The Preparation Step.

In the preparing step of the production method of the one or more embodiments disclosed and described herein, the catalyst composite that comprises an SnO₂ support and platinum or a platinum alloy supported on the surface thereof, and the ionomer that is a proton-conductive polymer, are prepared.

1-1. The SnO₂ Support.

According to the one or more embodiments disclosed and described herein, due to the use of the SnO₂ support, a fuel cell catalyst layer that is configured to provide high stability at high potentials, can be produced.

The SnO₂ support that may be used in the production method of the one or more embodiments disclosed and described herein, is not particularly limited, as long as it is able to support a catalyst (platinum or a platinum alloy) on its surface.

The average particle diameter of the SnO₂ support is not particularly limited, as long as it is in a range that is practically applicable to fuel cell catalyst layers. However, when the SnO₂ support particle diameter is too small compared to the particle diameter of the platinum particles or platinum alloy particles, it may be difficult to support the platinum particles or platinum alloy particles. When the SnO₂ support particle diameter is too large, the volume of the catalyst composite increases to increase the thickness of the catalyst layer too much. Therefore, a decrease in power generation performance may occur. Accordingly, the SnO₂ support particle diameter is preferably in a range of from 7.5 to 50 nm, more preferably in a range of from 20 to 30 nm, and still more preferably in a range of from 22 to 28 nm. Also in the one or more embodiments disclosed and described herein, the average particle diameter is determined by observing the SnO₂ support particles with a transmission electron microscope (TEM) at a magnification of 250000×, measuring the particle diameters of about 250 of the visually confirmed particles on the assumption that the particles are spherical, and determining the average of the particle diameters as the average particle diameter.

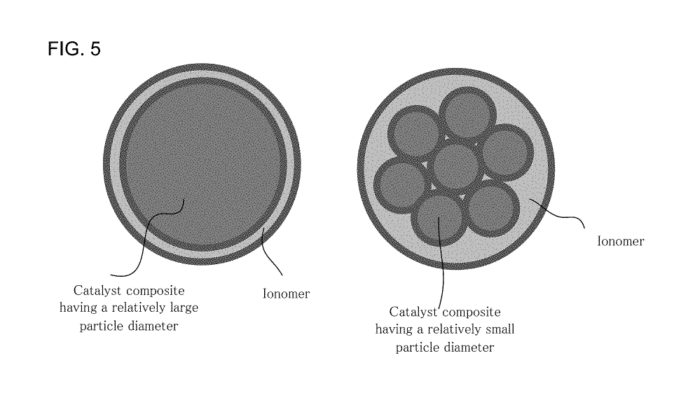

In the average particle diameter range that is practically applicable to the fuel cell catalyst layer, as shown in FIG. 5, secondary particles, each of which is composed of primary particles, are formed in the catalyst ink by the catalyst composite that comprises the SnO₂ support and the platinum or platinum alloy supported on the surface thereof. Each of the secondary particles thus formed is covered with the ionomer. However, regardless of the particle diameters of the primary particles, the sizes of the secondary particles are almost the same (the surface areas of the secondary particles per volume of the SnO₂ support are almost the same) and the distance between the primary particles in each secondary particle is quite small. Therefore, the amount of the ionomer present between the primary particles (i.e., inside each secondary particle) is quite small. Due to this reason, even if the average particle diameter of the SnO₂ support (primary particles) in the catalyst composite differs, there is no change in the optimal ionomer volume for covering the SnO₂ support having a fixed volume.

The apparent density of the SnO₂ support which is practically applicable to the fuel cell catalyst layer is, even if the average particle diameter or shape differs, in a range of from 3.9 to 4.0 g/cm³, since the composition remains the same. Therefore, even if the average particle diameter or shape of the SnO₂ support differs, there is no change in the optimal ionomer volume for covering the SnO₂ support having a fixed mass. The apparent density is a density that is calculated by packing the SnO₂ support in a screw bottle for which the volume is known, and measuring the mass of the packed SnO₂ support.

Therefore, there is no influence on the preferred I/MO ratio that is obtained from the examples described below, as long as the SnO₂ support is a support that is able to support the catalyst on the surface thereof.

From the viewpoint of electrical conductivity, the SnO₂ support is preferably doped with a different type of metal. As the metal, examples include, but are not limited to, tungsten and antimony. As the shape of the SnO₂ support, examples include, but are not limited to, particulate shapes such as a spherical shape and an oval spherical shape.

### 1-2. The Catalyst Composite.

The catalyst composite used in the production method of the one or more embodiments disclosed and described herein, is the SnO₂ support on which platinum or a platinum alloy, which serves as the catalyst, is supported.

As the shape of the platinum or platinum alloy supported as the catalyst, examples include, but are not limited to, particle shapes such as a spherical shape and an oval spherical shape. The average particle diameter is preferably in a range of from 3 to 10 nm, for example.

The amount of the platinum or platinum alloy supported on the surface of the SnO₂ support is not particularly limited. In general, the mass support ratio of the platinum or platinum alloy with respect to the catalyst composite is in a range of from 5 to 20% by mass. The mass support ratio can be obtained by the following formula (1):

Mass support ratio (%)=the mass of the catalyst/(the mass of the catalyst+the mass of the SnO₂ support)×100 Formula (1)

### 1-3. The Ionomer.

The ionomer used in the one or more embodiments disclosed and described herein, is not particularly limited, as long as it is a proton-conductive polymer. As the ionomer, examples include, but are not limited to, Nafion (trade name, manufactured by DuPont). Nafion is a perfluorocarbon composed of a hydrophobic Teflon' framework, which is composed of a carbon-fluorine bond, and a perfluorocarbon side chain, which includes a sulfonic acid group.

In general, ionomers that are practically applicable to the fuel cell catalyst layer, are similar in basic molecular structure, even if they are different types of ionomers. Accordingly, the polymer density is in a range of from 1.9 to 2.0 g/cm³. As described above, even if the type of the ionomer changes, there is no change in the optimal ionomer volume required for covering the SnO₂ support having a fixed mass. Therefore, the type of the ionomer has no influence on the preferred I/MO range obtained from the below-described examples. The polymer density can be calculated by producing a film having a uniform thickness and measuring the mass and volume of the film. However, since the polymer is an electrolyte and the apparent size varies depending on its moisture state, it is needed to measure the mass and volume when the polymer is in a dry state.

In general, for the ionomer used in the one or more embodiments disclosed and described herein, as the average molecular weight increases, the solubility decreases. On the other hand, as the average particle diameter decreases, the ionomer becomes friable. Therefore, the average molecular weight is generally in a range of from 10,000 to 200,000, preferably in a range of from 100,000 to 200,000, and still more preferably in a range of from 150,000 to 200,000. As used herein, the average molecular weight refers to a weight average molecular weight.

The ionomer used in the one or more embodiments disclosed and described herein, is preferably a perfluorocarbon sulfonic acid polymer comprising an acidic functional group and a cyclic group. This is because the ionomer has high gas diffusivity and can provide high power generation performance especially at high load (high current density). The perfluorocarbon sulfonic acid polymer comprising an acidic functional group and a cyclic group is more preferably a perfluorocarbon comprising a hydrophobic Teflon™ framework composed of a carbon-fluorine bond, and a perfluorocarbon side chain including a sulfonic acid group.

### 2. The Mixing Step.

In the fuel cell catalyst layer production method of the one or more embodiments disclosed and described herein, the catalyst composite, the ionomer and a dispersion medium are mixed in such conditions that the ratio (I/MO) of the mass (I) of the ionomer to the mass (MO) of the SnO₂ support is in a range of from 0.06 to 0.12, and the content of a solid comprising the catalyst composite and the ionomer is 24% by mass or more.

### 2-1. The Ratio (I/MO) of the Mass (I) of the Ionomer to the Mass (MO) of the SnO₂ Support.

In the mixing step of the fuel cell catalyst layer production method of the one or more embodiments disclosed and described herein, the ratio (I/MO) of the mass (I) of the ionomer to the mass (MO) of the SnO₂ support is in a range of from 0.06 to 0.12, in order to obtain the fuel cell catalyst layer that is configured to be usable in a wide range of humidity environments at a relative humidity of from 90 to 250% and provide high power generation performance over a range of from low to high loads, even if an SnO₂ support that is highly stable at high potentials is used as the support.

In general, when the ionomer amount is small compared to the electroconductive support in the catalyst ink, the catalyst and electroconductive support cannot be sufficiently covered with the ionomer, so that they cannot adapt to changes in the relative humidity of an external environment. When the ionomer amount is large compared to the electroconductive support in the catalyst ink, the thickness of the ionomer layer covering the catalyst and electroconductive support, increases to increase the resistance of the fuel cell catalyst layer thus produced. Therefore, the compositional ratio of the support and the ionomer has an appropriate range. For example, in the catalyst layer production method of Patent Literature 1, the weight ratio of a carbon support and an ionomer preferably ranges from 0.4 to 1.25. Compared to the preferred range of from 0.4 to 1.25 in the production method of Patent Literature 1, it is clear that the preferred I/MG range of from 0.06 to 0.12 in the production method of the one or more embodiments disclosed and described herein, in which the SnO₂ support is used, is a quite low range and absolutely differs from the case where the carbon support is used.

As described above, the optimal ionomer mass for covering the SnO₂ support having a fixed mass, is not influenced by the average particle diameter and shape of the SnO₂ support and by the type of the ionomer. Therefore, the fuel cell catalyst layer that is configured to be usable in a wide range of humidity environments and provide high power generation performance over a range of from low to high loads, can be obtained by using the SnO₂ support that is able to support platinum or a platinum alloy on the surface thereof and the ionomer that is a proton-conductive polymer, and by providing the I/MG in a range of from 0.06 to 0.12.

The SnO₂ support and the ionomer have a property of easily absorbing and releasing moisture. Even if the SnO₂ support and the ionomer are measured for mass in a dry state, there may be a margin of error of about 10%, depending on a slight difference in measurement condition. It is thus considered that the fuel cell catalyst layer that is configured to be usable in a wide range of humidity environments at a relative humidity of from 90 to 250% and provide high power generation performance over a range of from low to high loads, can be obtained when the ratio (I/MO) is in a range of ±0.01 of the experimentally-obtained ratio (I/MO) of the mass (I) of the ionomer to the mass (MO) of the SnO₂ support.

The I/MO is preferably in a range of from 0.10 to 0.12, since the low humidity side (lower limit) of the usable humidity is expanded, and the fuel cell catalyst layer that is configured to be usable in a quite wide range of humidity environments at a relative humidity of from 40 to 250%, can be obtained. From the viewpoint of practical applications, there is no need to install a humidifier or the like to supply a gas with a controlled relative humidity to a fuel cell electrode; therefore, a simplification of a fuel cell system can be achieved.

### 2-2. The Solid Concentration.

In the mixing step of the fuel cell catalyst layer production method of the one or more embodiments disclosed and described herein, the content of the solid comprising the catalyst composite and the ionomer in the catalyst ink is 24% by mass or more. In a catalyst ink comprising a carbon support, the content of the solid is generally about 3% by mass, which is absolutely different from the content of the one or more embodiments disclosed and described herein.

As described above, according to the one or more embodiments in which the SnO₂ support is used, in order to obtain the catalyst layer with desired performance, the mass of the ionomer with respect to the mass of the electroconductive support, is needed to be smaller than the case of using the carbon support. As a result, in the one or more embodiments in which the SnO₂ support is used, the content of the ionomer in the solid comprising the catalyst composite and the ionomer, is smaller than the case of using the carbon support.

Therefore, even if the catalyst ink comprising the SnO₂ support and the catalyst ink comprising the carbon support have the same solid concentration, compared to the catalyst ink comprising the carbon support, the catalyst ink comprising the SnO₂ support is smaller in the absolute amount of the ionomer that contributes to the formation of a higher-order structure, and obtains low viscosity.

However, the specific gravity of the SnO₂ support is larger than the carbon support, and high viscosity is needed to uniformly disperse the catalyst composite comprising the SnO₂ support in the catalyst ink. Therefore, if the catalyst ink has low viscosity, there is such a new problem that a uniform and transferrable catalyst layer cannot be formed by the casting method.

Therefore, in the production method of the one or more embodiments in which the SnO₂ support is used, the formation of the uniform and transferrable catalyst layer by the casting method, can be achieved by setting the content of the solid to 24% by mass or more and thereby increasing the viscosity of the catalyst ink.

The upper limit of the solid concentration is not particularly limited. To uniformly disperse the catalyst composite and the ionomer in the catalyst ink, the upper limit is preferably 40% by mass or less, and more preferably 30% by mass or less.

2-3. The dispersion medium.

The dispersion medium used in the production method of the one or more embodiments disclosed and described herein, is not particularly limited, as long as it contains at least water and an alcohol having 3 or 4 carbon atoms, and the content ratio of the alcohol in the dispersion medium is the highest.

In general, the composition of the dispersion medium used for the catalyst ink has a large influence on the dispersibility of the electroconductive support and ionomer and on the performance of the catalyst layer to be obtained. Therefore, the dispersion medium may be appropriately prepared depending on the type of the electroconductive support and ionomer used.

However, the SnO₂ support has a property of being easily modified in a reduction condition. Therefore, when the dispersion medium contains a large amount of alcohol having a small carbon number and relatively high reactivity, the SnO₂ support is modified and has a negative influence on electroconductivity or on the coverage of the catalyst composite with the ionomer.

In the production method of the one or more embodiments disclosed and described herein, by increasing the content ratio of the alcohol having 3 or 4 carbon atoms in the dispersion medium, the alcohol having relatively low reactivity, the dispersibility of the catalyst composite and ionomer can be maintained without modifying the SnO₂ support.

The alcohol is preferably t-butanol or isopropanol, in which a branched structure is included in the hydrocarbon group, and more preferably t-butanol, since the reactivity of the alcohol decreases.

### 3. The Dispersing Step.

In the fuel cell catalyst layer production method of the one or more embodiments disclosed and described herein, the aggregates comprising the catalyst composite and the ionomer are dispersed in the dispersion medium by pulverizing the aggregates by applying shear force, while preventing reaggregation of the pulverized aggregates by applying force.

As described above, if the content of the solid in the catalyst ink is increased for better casting properties, the aggregates comprising the catalyst composite and the ionomer are likely to be produced. Therefore, there is such a problem that the catalyst composite and the ionomer are less likely to be uniformly dispersed.

In the production method of the one or more embodiments disclosed and described herein, in order to uniformly disperse the catalyst composite and the ionomer, the aggregates are dispersed by pulverizing the aggregates by applying shear force, while preventing reaggregation of the pulverized aggregates by applying force.

When the solid concentration in the catalyst ink is increased to 24% or more, the aggregates comprising the SnO₂ support and the ionomer are likely to be produced. Therefore, in order to uniformly disperse the catalyst composite and the ionomer, the shear force of pulverizing the aggregates and the force for preventing the reaggregation of the pulverized aggregates are needed.

A device may be used in the dispersing step. The device is not particularly limited, and a device for pulverizing the aggregates may be used. As the device, examples include, but are not limited to, a planetary ball mill, a ball mill and a mixer, which have a property of applying shear force.

A device for preventing the reaggregation of the aggregates may be used. As the device, examples include, but are not limited to, a planetary ball mill, a ball mill and a homogenizer. The reaggregation preventing force of a ball mill is smaller than a planetary ball mill and a homogenizer.

Therefore, in the dispersing step of the one or more embodiments disclosed and described herein, it is preferable to use a planetary ball mill having both the shear force of pulverizing the aggregates and the force for preventing the reaggregation, or it is preferable to use a ball mill or mixer having the shear force of pulverizing the aggregates in combination with a homogenizer having the force for preventing the reaggregation. It is more preferable to use a planetary ball mill.

Here, the ball mill is a device for carrying out fine pulverization in such a manner that raw materials and balls, which serve as a pulverization medium, are put in a cylinder and rotated to finely disperse the raw materials by applying shear force that is derived from the collision and grinding of the balls and the raw materials.

The planetary ball mill is a device for carrying out fine pulverization by adding rotation/revolution movement to the ball mill and thereby applying stronger centrifugal force.

The mixer is a device for carrying out fine pulverization with applying shear force that is derived from the centrifugal force of pushing the contents against the inner wall of a container and the force of moving the contents by a rotating flow.

The homogenizer is a device for carrying out fine pulverization by applying ultrasonic vibration to a solution, producing fine bubbles due to the resulting pressure difference, and repeatedly applying a strong impact to substances in the solution.

The dispersion time is not particularly limited. It is preferably 3 hours or more, and more preferably 6 hours or more.

### 4. The Fuel Cell Catalyst Layer.

The fuel cell catalyst layer obtained by the production method of the one or more embodiments disclosed and described herein, contains the catalyst composite comprising the SnO₂ support and the platinum or platinum alloy supported on the surface thereof, and the ionomer covering the catalyst composite. The ratio (I/MO) of the mass (I) of the ionomer to the mass (MO) of the SnO₂ support is in a range of from 0.06 to 0.12. Therefore, the fuel cell catalyst layer can be used in a wide range of humidity environments and provide high power generation performance over a range of from low to high loads.

In the one or more embodiments disclosed and described herein, the fuel cell is not particularly limited, as long as it comprises a polyelectrolyte membrane and it converts chemical energy directly into electrical energy by supplying a fuel gas and an oxidant gas to electrodes, each of which comprises two electrically-connected catalyst layers, and thereby causing electrochemical oxidation of fuel.

The fuel cell of the one or more embodiments disclosed and described herein, is generally composed of a stack of fuel cells, each of which comprises a membrane electrode assembly (MEA) as the basic structure. The MEA is composed of electrodes, each of which comprises a pair of catalyst layers, and the polyelectrolyte membrane sandwiched between the electrodes. The catalyst layer obtained by the production method of the one or more embodiments disclosed and described herein, is applicable to both oxidant and fuel electrodes.

In addition to the catalyst layers, the electrodes may comprise a gas diffusion layer and a current collector.

### EXAMPLES

The production method of the one or more embodiments disclosed and described herein, will be further clarified by the following examples and comparative examples. All designations of “%” are “% by mass” unless otherwise specified.

### 1. Examination of Preferred I/MO Range.

### (Production of Catalyst Layers for Examination of I/MO)

### Example 1

a. Preparation Step

A catalyst composite (in which the mass support ratio of platinum supported on the surface of the following SnO₂ support manufactured by Mitsui Mining & Smelting Co., Ltd., is 15% by mass) and an ionomer dispersion (in which the following ionomer A was dispersed (10%) in a solution of water and isopropanol at a ratio of 1:1) were prepared.

The SnO₂ support is a tungsten-doped SnO₂ support having an average particle diameter of 25 nm and an apparent density of 3.9 g/cm².

The ionomer A is such a perfluorocarbon sulfonic acid polymer comprising an acidic functional group and a cyclic group, that has a polymer density of 1.9 g/cm² and is classified as a Nafion (trade name)-based fluorinated sulfonic acid polymer.

b. Mixing Step

The catalyst composite, the ionomer and a dispersion medium were mixed so as to have an I/MO (the ratio of the mass (I) of the ionomer A to the mass (MO) of the SnO₂ support) of 0.07 and the composition and solid concentration shown in Table 1. In the following tables, BM means planetary ball mill; EtOH means ethanol; IPA means isopropanol; and t-BuOH means t-butanol. Also in Table 1, percentages in parentheses shown in the columns of H₂O, EtOH and IPA are the content ratios of H₂O, EtOH and IPA in the dispersion medium.

TABLE 1

| | | | Main | | | | | | |
|---|---|---|---|---|---|---|---|---|---|
| | | | component of | Ink composition (g) | | | | | |
| | Solid | Dispersion | dispersion | Ionomer | Catalyst | | | | |
| | concentration | method | medium | dispersion | composite | H₂O | EtOH | IPA | I/MO |
| Comparative | 32% | BM | IPA | 0.32 | 1.00 | 0.744 (34%) | 0.65 (30%) | 0.774 (36%) | 0.04 |
| Example 1 | | | | | | | | | |
| Example 1 | 33% | BM | IPA | 0.64 | 1.00 | 0.778 (36%) | 0.48 (22%) | 0.878 (41%) | 0.07 |
| Example 2 | 34% | BM | IPA | 0.82 | 1.00 | 0.779 (37%) | 0.38 (18%) | 0.959 (45%) | 0.09 |
| Example 3 | 34% | BM | IPA | 0.97 | 1.00 | 0.777 (39%) | 0.32 (16%) | 1.007 (51%) | 0.11 |
| Comparative | 29% | BM | IPA | 1.46 | 1.00 | 0.967 (34%) | 0.40 (14%) | 1.477 (52%) | 0.17 |
| Example 2 | | | | | | | | | |
| Comparative | 24% | BM | IPA | 1.93 | 1.00 | 1.189 (32%) | 0.56 (15%) | 1.959 (53%) | 0.22 |
| Example 3 | | | | | | | | | |

c. Dispersing Step

The mixed solution thus obtained was dispersed at 300 rpm for 6 hours, by use of a planetary ball mill (product name: PM200; manufactured by: Retsch), thereby obtaining a catalyst ink.

d. Production of Catalyst Layers

The catalyst ink was cast on a polytetrafluoroethylene (PTFE) sheet so that the platinum amount was 0.2 mg per 1 cm² area of the catalyst layer. The cast catalyst ink was naturally dried. The PTFE sheet was cut into a 1 cm piece and used as the catalyst layer of Example 1. The catalyst layer and a Nafion membrane (product name: NR212; manufactured by: DuPont), which is an electrolyte membrane, were stacked and then attached by pressing them at 3 MPa and 140° C. for 4 minutes, thereby obtaining a membrane electrode assembly (MEA).

### Example 2

The catalyst layer and MEA of Example 2 were produced in the same manner as Example 1, except that the catalyst composite, the ionomer A and the dispersion medium were mixed so as to have an I/MO of 0.09 and the composition and solid concentration of Example 2 shown in Table 1.

### Example 3

The catalyst layer and MEA of Example 3 were produced in the same manner as Example 1, except that the catalyst composite, the ionomer A and the dispersion medium were mixed so as to have an I/MO of 0.11 and the composition and solid concentration of Example 3 shown in Table 1.

### Comparative Example 1

The catalyst layer and MEA of Comparative Example 1 were produced in the same manner as Example 1, except that the catalyst composite, the ionomer A and the dispersion medium were mixed so as to have an I/MO of 0.04 and the composition and solid concentration of Comparative Example 1 shown in Table 1.

### Comparative Example 2

The catalyst layer and MEA of Comparative Example 2 were produced in the same manner as Example 1, except that the catalyst composite, the ionomer A and the dispersion medium were mixed so as to have an I/MO of 0.17 and the composition and solid concentration of Comparative Example 2 shown in Table 1.

### Comparative Example 3

The catalyst layer and MEA of Comparative Example 3 were produced in the same manner as Example 1, except that the catalyst composite, the ionomer A and the dispersion medium were mixed so as to have an I/MO of 0.22 and the composition and solid concentration of Comparative Example 3 shown in Table 1.

### 2. Examination of Solid Concentration.

### 2-1. Production of Catalyst Layers for Examination of Solid Concentration.

### Example 4

The catalyst layer of Example 4 was produced in the same manner as Example 1, except that the catalyst composite, the ionomer A and the dispersion medium were mixed so as to have an I/MO of 0.11, a solid concentration of the catalyst composite and ionomer A of 24% by mass, and the composition of Example 4 shown in Table 2.

TABLE 2

| | | | Main | | | | | | |
|---|---|---|---|---|---|---|---|---|---|
| | | | component of | Ink composition (g) | | | | | |
| | Solid | Dispersion | dispersion | Ionomer | Catalyst | | | | |
| | concentration | method | medium | dispersion | composite | H₂O | EtOH | IPA | I/MO |
| Example 4 | 24% | BM | IPA | 5.00 | 5.00 | 5.47 (32%) | 4.23 (25%) | 7.30 (43%) | 0.11 |
| Comparative | 3% | BM | IPA | 0.82 | 0.85 | 10.23 (30%) | 8.41 (25%) | 15.62 (46%) | 0.11 |
| Example 4 | | | | | | | | | |

### Comparative Example 4

The catalyst layer of Comparative Example 4 was produced in the same manner as Example 1, except that the catalyst composite, the ionomer A and the dispersion medium were mixed so as to have an I/MO of 0.11, a solid concentration of 3% by mass, and the composition of Comparative Example 4 shown in Table 2.

### 3. Examination of Dispersion Medium Composition.

### (Production of Catalyst Layers for Examination of Dispersion Medium Composition)

### Example 5

The catalyst layer and MEA of Example 5 were produced in the same manner as Example 1, except that the catalyst composite, the ionomer A and the dispersion medium were mixed so as to have an I/MO of 0.07 and the composition and solid concentration of Example 5 shown in Table 3, in which the content ratio of the isopropanol in the dispersion medium is the highest.

TABLE 3

| | | | Main | | | | | | | |
|---|---|---|---|---|---|---|---|---|---|---|
| | | | component of | Ink composition (g) | | | | | | |
| | Solid | Dispersion | dispersion | Ionomer | Catalyst | | | | | |
| | concentration | method | medium | dispersion | composite | H₂O | EtOH | IPA | t-BuOH | I/MO |
| Example 5 | 33% | BM | IPA | 0.64 | 1.00 | 0.778 (36%) | 0.48 (22%) | 0.878 (41%) | 0.00 (0%) | 0.07 |
| Example 6 | 39% | BM | t-BuOH | 0.64 | 1.00 | 0.778 (36%) | 0.00 (0%) | 0.288 (21%) | 1.07 (39%) | 0.07 |
| Comparative | 27% | BM | EtOH | 3.4 | 5.00 | 3.13 (33%) | 5.67 (39%) | 2.7 (29%) | 0.00 (0%) | 0.07 |
| Example 5 | | | | | | | | | | |

### Example 6

The catalyst layer and MEA of Example 6 were produced in the same manner as Example 1, except that the catalyst composite, the ionomer A and the dispersion medium were mixed so as to have an I/MO of 0.07 and the composition and solid concentration of Example 6 shown in Table 3, in which the content ratio of the t-butanol in the dispersion medium is the highest.

### Comparative Example 5

The catalyst layer and MEA of Comparative Example 5 were produced in the same manner as Example 1, except that the catalyst composite, the ionomer A and the dispersion medium were mixed so as to have an I/MO of 0.07 and the composition and solid concentration of Comparative Example 5 shown in Table 3, in which the content ratio of the ethanol in the dispersion medium is the highest.

### 4. Examination of Dispersion Method.

### (Production of Catalyst Layers for Examination of Dispersion Method)

### Example 7

The catalyst layer and MEA of Example 7 were produced in the same manner as Example 1, except that the catalyst composite, the ionomer A and the dispersion medium were mixed so as to have an I/MO of 0.07 and the composition and solid concentration of Example 7 shown in Table 4, and the dispersion time was 3 hours in the dispersing step.

TABLE 4

| | | | Main | | | | | | |
|---|---|---|---|---|---|---|---|---|---|
| | | | component of | Ink composition (g) | | | | | |
| | Solid | Dispersion | dispersion | Ionomer | Catalyst | | | | |
| | concentration | method | medium | dispersion | composite | H₂O | EtOH | IPA | I/MO |
| Example 7 | 32% | BM (3 h) | IPA | 0.64 | 1.00 | 0.778 (36%) | 0.48 (22%) | 0.878 (41%) | 0.07 |
| Example 8 | 33% | BM (6 h) | IPA | 0.64 | 1.00 | 0.778 (36%) | 0.48 (22%) | 0.878 (41%) | 0.07 |
| Example 9 | 31% | Homogenizer | IPA | 3.54 | 5.50 | 4.533 (39%) | 3.09 (27%) | 5.173 (45%) | 0.07 |
| | | & FM mixer | | | | | | | |
| Comparative | 28% | HS mixer | IPA | 0.62 | 0.92 | 0.849 (34%) | 0.80 (32%) | 0.879 (35%) | 0.07 |
| Example 6 | | | | | | | | | |

### Example 8

The catalyst layer and MEA of Example 8 were produced in the same manner as Example 1, except that the catalyst composite, the ionomer A and the dispersion medium were mixed so as to have an I/MO of 0.07 and the composition and solid concentration of Example 8 shown in Table 4.

### Example 9

The catalyst layer and MEA of Example 9 were produced in the same manner as Example 1, except that the catalyst composite, the ionomer A and the dispersion medium were mixed so as to have an I/MO of 0.07 and the composition and solid concentration of Example 9 shown in Table 4, and a homogenizer (product name: Ultrasonic generator GSCVP-600; manufactured by: UCE) was used in combination with an FM mixer (product name: FILMIX Model 80; manufactured by: PRIMIX Corporation) in the dispersing step.

### Comparative Example 6

The catalyst layer and MEA of Comparative Example 6 were produced in the same manner as Example 1, except that the catalyst composite, the ionomer A and the dispersion medium were mixed so as to have an I/MO of 0.07 and the composition and solid concentration of Comparative Example 6 shown in Table 4, and an HS mixer (product name: ULTRA-TURRAX T8; manufactured by: IKA) was used in the dispersing step.

### 5. Evaluation of Catalyst Layer Performance.

### 5-1. Evaluation of Power Generation Performance Under Low Load.

Power generation was carried out by fuel cells having the above-obtained MEAs incorporated therein. In several relative humidity conditions, the voltage output values (V) at a current density of 0.2 A/cm² were calculated. Measurement conditions at the several relative humidities are as follows:

(40% RH)
Anode gas: Hydrogen gas at a relative humidity (RH) of 40% (bubbler dew point 80° C.)
Cathode gas: Pure oxygen at a relative humidity (RH) of 40% (bubbler dew point 80° C.)
Cell temperature (cooling water temperature): 80° C.

(90% RH)
Anode gas: Hydrogen gas at a relative humidity (RH) of 90% (bubbler dew point 80° C.)
Cathode gas: Pure oxygen at a relative humidity (RH) of 90% (bubbler dew point 80° C.)
Cell temperature (cooling water temperature): 80° C.

(250% RH)
Anode gas: Hydrogen gas at a relative humidity (RH) of 2500 (bubbler dew point 50° C.)
Cathode gas: Pure oxygen at a relative humidity (RH) of 2500 (bubbler dew point 50° C.)
Cell temperature (cooling water temperature): 50° C.

### 5-2. Evaluation of Power Generation Performance Under High Load.

Power generation was carried out by fuel cells having the above-obtained MEAs incorporated therein. The current density (A/cm²) at an output voltage value of 0.6 V was calculated for each of the fuel cells, in the following condition:
Anode gas: Hydrogen gas at a relative humidity (RH) of 90% (bubbler dew point 80° C.)
Cathode gas: Pure oxygen at a relative humidity (RH) of 90% (bubbler dew point 80° C.)
Cell temperature (cooling water temperature): 80° C. 5-3. Measurement of coverage of platinum surface with ionomer.

The coverage of the platinum surface of the catalyst layer with the ionomer (ionomer coverage) was measured. The ionomer coverage was calculated by use of an electrochemical surface area (ECSA) value of the platinum, which was calculated by carrying out cyclic voltammetry (CV) measurement on one of the electrodes in a fluorine solvent, and an ECSA value of the platinum, which was calculated by carrying out CV measurement in a water solvent.

More specifically, the ECSA of the platinum in Fluoriner™ FC-3283 (product name; manufactured by: 3M) was calculated by use of the fuel cells having the above-obtained MEAs incorporated therein. Fluoriner™ was supplied to the cathode of each of the above-produced fuel cells to immerse the cathode in Fluorinert™. Also, humidified hydrogen gas was supplied to the anode at a supply flow rate of 0.5 (NL/min). At this time, the temperatures of the anode and cathode were 40° C., and the dew point of the anode was 40° C.

CV measurement of each of the fuel cells was carried out when the cathode was immersed in Fluoriner™ and the anode was supplied with hydrogen. The current (A) flowing through each of the fuel cells was measured when the voltage applied to each of the fuel cells was in a range of 0 to 1.0 V and the sweep rate was 50 mV/sec. The cyclic voltammogram of each of the fuel cells was obtained from the relationship between the thus-obtained voltage and current. A value was obtained by dividing the charge amount (C) at the hydrogen desorption peak by the charge amount (C/m²)per unit active surface area of the platinum and the mass (g) of the platinum. From the value thus obtained, the ECSA (m²/g-Pt) of the platinum in the fluorine solvent was calculated.

The ECSA of the platinum in the water solvent was calculated in the same manner as the method of measuring the ECSA of the platinum in the fluorine solvent, except that in place of Fluoriner™, the cathode of each of the fuel cells having the above-produced MEAs incorporated therein, was immersed in ultrapure water by supplying the ultrapure water to the cathode.

The ionomer coverage was calculated by the following formula (1):

The ionomer coverage=the ECSA (m²/g-Pt) of the platinum in the fluorine solvent/the ECSA (m²/g-Pt) of the platinum in the water solvent×100 Formula (1)

### 5-4. Evaluation of Humidity Dependence of Electrochemical Surface Area (ECSA).

The humidity dependence of the ECSA was evaluated by calculating the ratio (%) of the ECSA measured in a relative humidity condition of 40% to the ECSA measured in a relative humidity condition of 90%, by the following method. More specifically, the humidity dependence was calculated by dividing the ECSA measured in a relative humidity condition of 40% by the ECSA measured in a relative humidity condition of 90%.

### 6. Results of Examinations.

### 6-1. Results of Examination of Preferred I/MO Range.

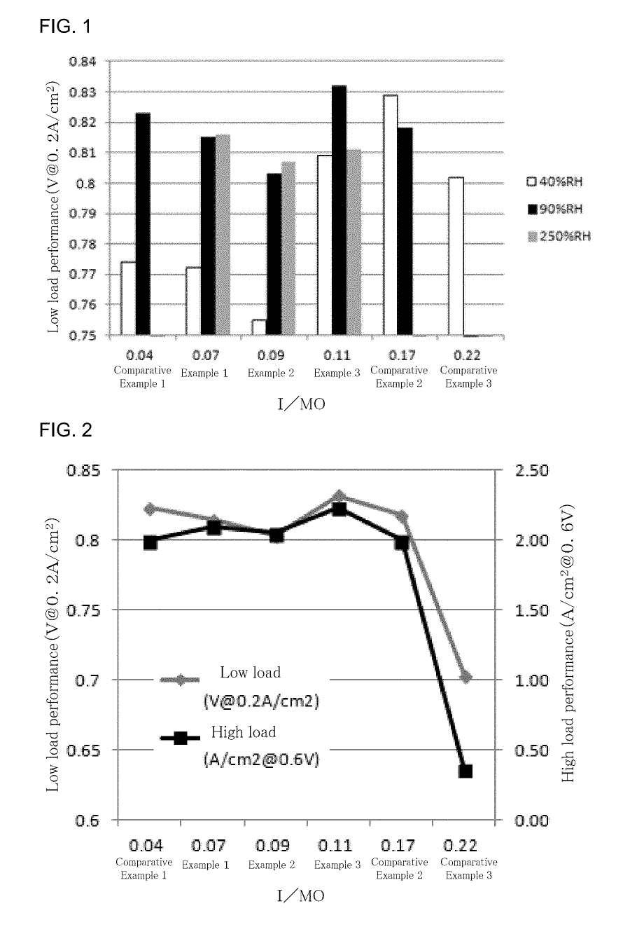

The results of the examination of the preferred I/MO range are shown in Table 5 and FIGS. 1 and 2.

TABLE 5

| | | | | Power generation | Power generation |
|---|---|---|---|---|---|
| | | Power generation performance | | performance | performance |
| | | (80° C./90% RH) | | (80° C./40% RH) | (50° C./250% RH) |
| | | Low load | High load | Low load | Low load |
| | I/MO | (V@0.2 A/cm²) | (A/cm²@0.6 V) | (V@0.2 A/cm²) | (V@0.2 A/cm²) |
| Comparative | 0.04 | 0.823 | 2.00 | 0.774 | 0.656 |
| Example 1 | | | | | |
| Example 1 | 0.07 | 0.815 | 2.10 | 0.772 | 0.816 |
| Example 2 | 0.09 | 0.803 | 2.05 | 0.755 | 0.807 |
| Example 3 | 0.11 | 0.832 | 2.23 | 0.809 | 0.811 |
| Comparative | 0.17 | 0.818 | 2.00 | 0.829 | 0.747 |
| Example 2 | | | | | |
| Comparative | 0.22 | 0.703 | 0.36 | 0.802 | 0.261 |
| Example 3 | | | | | |

As is clear from Table 5 and FIG. 1, Comparative Example 1, which has an I/MO of 0.04, can provide relatively high low load power generation performance in a relative humidity condition of 90% RH. However, Comparative Example 1 cannot maintain power generation performance in relative humidity conditions of 40% RH and 250% RH. This is considered to be because, since the mass of the ionomer A is small with respect to the mass of the SnO₂ support, the catalyst composite cannot be sufficiently covered with the ionomer.

Comparative Example 3, which has an I/MO of 0.22, can provide relatively high power generation performance in a relative humidity condition of 40% RH. However, Comparative Example 3 cannot maintain power generation performance in relative humidity conditions of 90% RH and 250% RH. This is considered to be because, since the mass of the ionomer A is excessive with respect to the mass of the SnO₂ support, the thickness of the ionomer layer covering the catalyst composite is too thick.

Comparative Example 2, which has an I/MO of 0.17, can provide relatively high power generation performance in relative humidity conditions of 40% RH and 90% RH. However, Comparative Example 2 cannot maintain power generation performance in a relative humidity condition of 250% RH. Compared to Comparative Examples 1 and 3, Comparative Example 2 has higher robustness to humidity variation. However, Comparative Example 2 can only adapt to relatively low humidity environments. In general, a fuel cell can adapt to low humidity environments by being equipped with a humidifier and humidifying the environments with the humidifier. However, it cannot adapt to high humidity environments, because it cannot dehumidify the environments. Therefore, the catalyst layer of Comparative Example 2 cannot achieve the purpose of adapting to a wide range of humidity environments where the fuel cell is expected to be used.

In contrast, the catalyst layers of Examples 1 to 3, which have an I/MO in a range of 0.07 to 0.11, can provide relatively high low load power generation performance in relative humidity conditions of at least 90% RH and 250% RH. Therefore, when used in combination with a humidifier, the catalyst layers of Examples 1 to 3 can achieve the purpose of adapting to a wide range of humidity environments where the fuel cell is expected to be used.

Especially, the catalyst layer of Example 3, which has an I/MO of 0.11, could provide relatively high power generation performance in a wide range of humidity environments of 40% RH, 90% RH and 250% RH. That is, it is clear that the catalyst layer produced to have an I/MO of 0.11, can achieve the purpose of adapting to a wide range of humidity environments where the fuel cell is expected to be used, without a humidifier.

From Table 5 and FIG. 2, it is also clear that fuel cells comprising the catalyst layers of Examples 1 to 3, which have an I/MO in a range of 0.07 to 0.11, can provide an output voltage of 0.8 V or more in a low load condition of 0.2 A/cm² (90% RH) and a current density of 2.0 A/cm² or more in a high load condition (90% RH) of a voltage of 0.6 V.

### 6-2. Results of Examination of Solid Concentration.

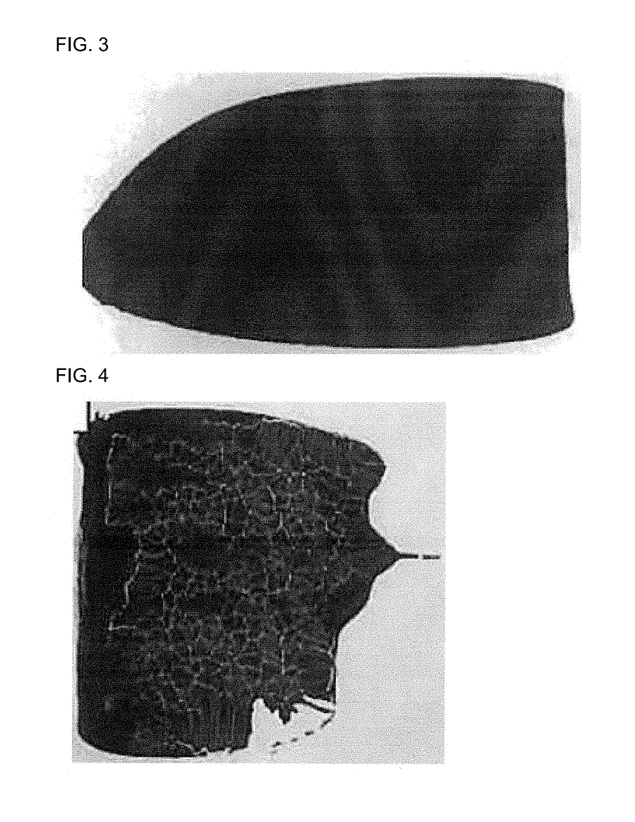

FIG. 3 shows a photograph of the catalyst layer of Example 4 in which the concentration of the solid comprising the catalyst composite and ionomer A in the catalyst ink was 24% in the mixing step. FIG. 4 shows a photograph of the catalyst layer of Comparative Example 4 in which the solid concentration was 3%.

As shown in FIG. 4, it is clear that cracks occur on the surface of the catalyst layer of Comparative Example 4 having a solid concentration of 3%. Meanwhile, as shown in FIG. 3, it is clear that the surface of the catalyst layer of Example 4 having a solid concentration of 24%, is smooth.

Even for Examples 1 to 3 having a solid concentration of 30% or more, the surface of the catalyst layer was smooth. Therefore, it is considered that the reason for the cracks is because the catalyst ink comprising such an SnO₂ support that the preferred I/MO range is in a range of 0.07 to 0.11 and is lower than the catalyst ink comprising the carbon support, has poor viscosity and it cannot be uniformly cast when the solid concentration is less than 24%.

Performance evaluation was not carried out on the catalyst layer of Comparative Example 4, because the surface of the catalyst layer had cracks and no MEA could be produced therewith.

### 6-3. Results of Examination of Dispersion Medium Composition.

The results of examination of the dispersion medium composition are shown in Table 6.

TABLE 6

| | | Power generation performance | | | |
|---|---|---|---|---|---|
| | | (80° C./90% RH) | | | |
| | Main component of | Low load | High load | Ionomer | ECSA humidity |
| | dispersion medium | (V@0.2 A/cm²) | (A/cm²@0.6 V) | coverage | dependence |
| Example 5 | IPA | 0.84 | 1.69 | 99% | 78% |
| Example 6 | t-BuOH | 0.853 | 1.81 | 99% | 80% |
| Comparative | EtOH | 0.836 | 1.33 | 94% | 60% |
| Example 5 | | | | | |

As is clear from Table 6, for the catalyst layer of Comparative Example 5 in which the main component of the dispersion medium is ethanol, the output voltage is 0.836 V at a current density of 0.2A/cm², and there is no problem with power generation performance under low load. However, the current density is 1.33 A/cm² at an output voltage of 0.6 V and resulted in low power generation performance under high load. That is, although the I/MO is 0.07, the catalyst layer could not provide high power generation performance over a range of from low to high loads. Also, the catalyst layer is considered to have low robustness to humidity, since the ionomer coverage and the ECSA humidity dependence are as low as 94% and 60%, respectively.

Meanwhile, for the catalyst layer of Example 5 in which the main component of the dispersion medium is isopropanol having 3 carbon atoms, the output voltage is 0.84 V at a current density of 0.2 A/cm², and the current density is 1.69 A/cm² at an output voltage of 0.6 V. That is, the catalyst layer could provide high power generation performance over a range of from low to high loads. Also, the catalyst layer is considered to have high robustness to humidity, since the ionomer coverage and the ECSA humidity dependence are as high as 99% and 78%, respectively.

For the catalyst layer of Example 6 in which the main component of the dispersion medium is t-butanol having 4 carbon atoms, the output voltage is 0.853 V at a current density of 0.2 A/cm², and the current density is 1.81 A/cm² at an output voltage of 0.6 V. That is, the catalyst layer could provide higher power generation performance than isopropanol, over a range of from low to high loads. Also, the catalyst layer is considered to have higher robustness to humidity than isopropanol, since the ionomer coverage and the ECSA humidity dependence are as high as 99% and 80%, respectively.

### 6-4. Results of Examination of Dispersion Method.

The results of examination of the dispersion method are shown in Table 7.

TABLE 7

| | | Power generation performance | | | |
|---|---|---|---|---|---|
| | Dispersion | Low load | High load | Ionomer | ECSA humidity |
| | method | (V@0.2 A/cm²) | (A/cm²@0.6 V) | coverage | dependence |
| Example 7 | BM (3 h) | 0.805 | 1.95 | 99% | 80% |
| Example 8 | BM (6 h) | 0.815 | 2.10 | 99% | 89% |
| Example 9 | Homogenizer | 0.8 | 1.94 | 94% | 72% |
| | & FM Mixer | | | | |
| Comparative | HS Mixer | 0.796 | 1.42 | 79% | 53% |
| Example 6 | | | | | |

As is clear from Table 7, for the catalyst layer of Comparative Example 6 in which the HS mixer (a mixer for pulverizing aggregated particles by shear force that is derived from the centrifugal force of pushing the particles against the inner wall of a container and the force of moving the particles by a rotating flow) was used alone, the output voltage is 0.796 V at a current density of 0.2 A/cm², and there is no problem with power generation performance under low load. However, the current density is 1.42 A/cm² at an output voltage of 0.6 V and resulted in low power generation performance under high load. That is, although the I/MO is 0.07, the catalyst layer could not provide high power generation performance over a range of from low to high loads. Also, the catalyst layer is considered to have low robustness to humidity, since the ionomer coverage and the ECSA humidity dependence are as low as 79% and 53%, respectively.

As described above, aggregates of the catalyst composite and the ionomer are likely to form when the solid concentration is increased to 24% or more for the purpose of increasing the viscosity of the catalyst ink having a low I/MO to an extent that can disperse the SnO₂ support having a large specific gravity. To uniformly disperse the catalyst composite and the ionomer in the dispersion medium, applying the shear force of pulverizing the aggregates and the force for preventing the reaggregation of the pulverized aggregates is needed. The HS Mixer can pulverize the aggregates by the grinding shear force derived from the centrifugal force of pushing the aggregates against the inner wall of a container and the force of moving the aggregates by a rotating flow. However, once the pulverized aggregates move away from the rotating flow, they reaggregate and make it difficult to keep them dispersed. Therefore, for Comparative Example 6 in which the HS mixer was used alone, it is considered that the aggregates could not be sufficiently pulverized and uniformly dispersed in the dispersing step.

Meanwhile, for the catalyst layer of Example 9 in which the homogenizer (that has the force for preventing the reaggregation by applying ultrasonic vibration to a solution, producing fine bubbles due to the resulting pressure difference, and repeatedly applying a strong impact to substances in the solution) was used in combination with the FM mixer (that pulverizes aggregated particles by shear force that is derived from the centrifugal force of pushing the particles against the inner wall of a container and the force of moving the particles by a rotating flow), the output voltage is 0.8 V at a current density of 0.2 A/cm², and the current density is 1.94 A/cm² at an output voltage of 0.6 V. That is, the catalyst layer could provide high power generation performance over a range of from low to high loads. Also, the catalyst layer is considered to have high robustness to humidity, since the ionomer coverage and the ECSA humidity dependence are as high as 94% and 72%, respectively.

For the catalyst layer of Example 7 in which the dispersion was carried out for 3 hours by the use of the planetary ball mill that has both the shear force of pulverizing the aggregates and the force for preventing the reaggregation, the output density is 0.805 V at a current density of 0.2 A/cm², and the current density is 1.95 A/cm² at an output voltage of 0.6 V. That is, the catalyst layer could provide high power generation performance over a range of from low to high loads. Also, the catalyst layer is considered to have high robustness to humidity, since the ionomer coverage and the ECSA humidity dependence are as high as 99% and 80%, respectively.

For the catalyst layer of Example 8 in which the dispersion was carried out for 6 hours by the use of the planetary ball mill, the output voltage is 0.815 V at a current density of 0.2 A/cm², and the current density is 2.10 A/cm² at an output voltage of 0.6 V. That is, the catalyst layer could provide very high power generation performance over a range of from low to high loads. Also, the catalyst layer is considered to have high robustness to humidity, since the ionomer coverage and the ECSA humidity dependence are as high as 99% and 89%, respectively.

From the above results, it is clear that the fuel cell catalyst layer that is configured to be usable in a wide range of humidity environments and provide high power generation performance over a range of from low to high loads, can be provided by the fuel cell catalyst layer production method of the one or more embodiments disclosed and described herein, the method comprising the steps of: preparing a catalyst composite that comprises an SnO₂ support and platinum or a platinum alloy supported on the surface thereof, and an ionomer that is a proton-conductive polymer; mixing the catalyst composite, the ionomer and a dispersion medium containing at least water and an alcohol having 3 or 4 carbon atoms where the content ratio of the alcohol is higher than the water, in such conditions that the ratio (I/MO) of the mass (I) of the ionomer to the mass (MO) of the SnO₂ support is in a range of from 0.06 to 0.12, and the content of a solid comprising the catalyst composite and the ionomer is 24% by mass or more; and dispersing aggregates comprising the catalyst composite and the ionomer in the dispersion medium, by pulverizing the aggregates by applying shear force, while preventing reaggregation of the pulverized aggregates by applying force.

1. A method for producing a fuel cell catalyst layer, the method comprising the steps of:
preparing a catalyst composite that comprises an SnO₂ support and platinum or a platinum alloy supported on a surface thereof, and an ionomer that is a proton-conductive polymer;
mixing the catalyst composite, the ionomer and a dispersion medium containing at least water and an alcohol having 3 or 4 carbon atoms where a content ratio of the alcohol is higher than the water, in such conditions that a ratio (I/MO) of a mass (I) of the ionomer to a mass (MO) of the SnO₂ support is in a range of from 0.06 to 0.12, and a content of a solid comprising the catalyst composite and the ionomer is 24% by mass or more; and
dispersing aggregates comprising the catalyst composite and the ionomer in the dispersion medium, by pulverizing the aggregates by applying shear force, while preventing reaggregation of the pulverized aggregates by applying force.

2. The method for producing the fuel cell catalyst layer according to claim 1, wherein, in the mixing step, the ratio (I/MO) of the mass (I) of the ionomer to the mass (MO) of the SnO₂ support is in a range of from 0.10 to 0.12.

3. The method for producing the fuel cell catalyst layer according to claim 1, wherein the alcohol is t-butanol or isopropanol.

4. The method for producing the fuel cell catalyst layer according to claim 1, wherein a planetary ball mill is used in the dispersing step, or a ball mill or mixer is used in combination with a homogenizer in the dispersing step.

5. The method for producing the fuel cell catalyst layer according to claim 1, wherein the ionomer is a perfluorocarbon sulfonic acid polymer comprising an acidic functional group and a cyclic group.

6. The method for producing the fuel cell catalyst layer according to claim 1, wherein the solid content of the catalyst composite and ionomer is 40% by mass or less.
